(19) United States
(12) Patent Application Publication
(10) Pub. No.: US 2025/0070278 A1
(43) Pub. Date: Feb. 27, 2025

(54) ENERGY STORAGE SYSTEM AND BATTERY PACK

(71) Applicant: SK ON CO., LTD., Seoul (KR)

(72) Inventors: Jong Ho SEOK, Daejeon (KR); Yong Uk KIM, Daejeon (KR); Won Seok DO, Daejeon (KR); Bon A GOO, Daejeon (KR); Chan Ho PARK, Daejeon (KR); Woo Jin LEE, Daejeon (KR)

(21) Appl. No.: 18/753,715

(22) Filed: Jun. 25, 2024

(30) Foreign Application Priority Data
Aug. 25, 2023 (KR) 10-2023-0111866

(51) Int. Cl. H01M 10/42; H01M 50/204

(52) U.S. Cl. CPC H01M 10/425; H01M 50/204; H01M 2010/4271; H01M 2010/4278

(57) ABSTRACT

An energy storage system of disclosed technology include: a plurality of battery racks, each of the plurality of battery racks structured to support a plurality of battery cells; a management controller configured to be in communication with and to control the battery cells in the plurality of battery racks; and one or more connection lines configured to connect the management controller to the plurality of battery racks to form a network.

### CROSS-REFERENCE TO RELATED PATENT APPLICATION

This patent document claims the priority and benefits of Korean patent application number 10-2023-0111866 filed on Aug. 25, 2023, the entire disclosure of which is incorporated herein by reference.

### TECHNICAL FIELD

### 1. Field

The technology and implementations disclosed in this patent document generally relate to an energy storage system and a battery pack. Specifically, it relates to an energy storage system and a battery pack with improved communication stability.

### BACKGROUND

Secondary batteries are batteries that convert electrical energy into chemical energy and store it so that it may be reused multiple times through charging and discharging. Secondary batteries are widely used across industries due to their economical and eco-friendly characteristics. In particular, among secondary batteries, lithium secondary batteries are widely used in various devices including portable devices that require high-density energy.

### SUMMARY

The disclosed technology can be implemented in some embodiments to provide an energy storage system and a battery pack including a network that can reduce complexity when communicating between a plurality of secondary batteries.

In addition, the disclosed technology can be implemented in some embodiments to provide an energy storage system and a battery pack including a network with improved communication stability.

Some embodiments of the disclosed technology may be applied to electric vehicles, battery charging stations, and green technology, such solar power generation, and wind power generation using batteries.

In addition, battery cells implemented based on some embodiments of the disclosed technology may be used in eco-friendly electric vehicles, hybrid vehicles, etc. to prevent climate change by suppressing air pollution and greenhouse gas emissions.

An energy storage system of the disclosed technology includes:
a plurality of battery racks, each of the plurality of battery racks structured to support a plurality of battery cells; a management controller configured to be in communication with and to control the battery cells in the plurality of battery racks; and one or more connection lines configured to connect the management controller to the plurality of battery racks to form a network;
wherein each of the plurality of battery racks includes: a rack controller configured to communicate with the management controller or another battery rack other than a corresponding battery rack or to control battery cells included in the corresponding battery rack; and a first port and a second port configured to connect to the other battery rack; wherein the one or more connection lines include: a first connection line configured to connect, to the management controller, a first battery rack that is first connected to the management controller on the network among the plurality of battery racks; an intermediate connection line configured to connect the second port of any one battery rack among the plurality of battery racks on the network to the first port of another battery rack adjacent to the any one battery rack; and a second connection line configured to connect a main communication port of the second port of a second battery rack positioned last among the plurality of battery racks on the network to a spare communication port of the second port of the second battery rack.

The each of plurality of battery racks may include a first channel configured to transmit electrical signals between the first port and the second port through the rack controller; and a second channel configured to transmit signals between the first port and the second port within the plurality of battery racks.

The connection line may be connected to the first channel or the second channel to form an ethernet-based network.

The ethernet-based network may be formed by the second channel upon interruption of communication of any one of the first channels.

The first channel may be connected to the main communication port, and the second channel may be connected to the spare communication port.

The main communication port and the spare communication port may be connected to form a ring network.

The ring network may configured to transmit signals in a first direction from the first battery rack to the second battery rack or in a second direction from the second battery rack to the first battery rack on the network.

The intermediate connection line may include a plurality of cables, a part of the plurality of cables being connected to the first channel, and the remaining part of the plurality of cables being connected to a second channel.

The number of cables connected to the first channel may be the same as the number of cables connected to the second channel.

A battery pack of the disclosed technology includes: a plurality of battery modules, each of the plurality of battery modules including a plurality of battery cells; a management controller configured to be in communication with, and to control, the plurality of battery modules; and one or more connection lines coupled to connect the management controller and the plurality of battery modules to form an ethernet-based network; wherein each of the plurality of battery modules includes: a module controller configured to communicate with the management controller or another battery module other than a corresponding battery module or to control battery cells included in the corresponding battery module; and a first port and a second port configured to connect to the management controller or the other battery rack; wherein the connection line includes: a first connection line configured to connect, to the management controller, a first port of a first battery module that is first connected to the management controller on the network among the plurality of battery modules; an intermediate connection line configured to connect a second port of any one battery module among the plurality of battery modules on the network to a first port of another battery module adjacent to the any one battery module; and a second connection line configured to connect a main communication port of a second port of a second battery module positioned last among the plurality of battery modules on the network to a spare communication port of the second port of the second battery module.

Each of the plurality of battery modules includes: a first channel configured to transmit electrical signals between the first port and the second port through the module controller; and a second channel configured to transmit signals between the first port and the second port within the plurality of battery racks.

The first channel is connected to the main communication port, and the second channel is connected to the spare communication port.

A problem that the disclosed technology aims to solve is to provide an energy storage system and a battery pack including a network that can reduce complexity when communicating between a plurality of secondary batteries.

In addition, the disclosed technology may provide an energy storage system and a battery pack including a network with improved communication stability.

### BRIEF DESCRIPTION OF THE DRAWINGS

FIG. 1 shows an example of an energy storage system based on an embodiment of the disclosed technology.

FIG. 2 shows an example of a network based on an embodiment of the disclosed technology.

FIG. 3 shows examples of battery racks connected to each other by a first connection line of the disclosed technology.

FIGS. 4A and 4B show examples of a first channel and a second channel based on an embodiment of the disclosed technology.

FIG. 5 shows an example of a second connection line based on an embodiment of the disclosed technology.

FIG. 6 shows an example of a battery pack based on an embodiment of the disclosed technology.

### DETAILED DESCRIPTION

Hereinafter, some embodiments of the disclosed technology will be described in detail with reference to the attached drawings.

Specific terms used in the present specification are merely for convenience of explanation and are not used to limit the illustrated embodiments.

Secondary batteries may be used in groups for high capacity and high output performance. When a group of secondary batteries is used, a network is formed to exchange, between secondary batteries, information for checking and controlling the status of each secondary battery.

In a case where secondary batteries form a network, even when communication of any one of the secondary batteries is interrupted, electrical signals should be smoothly transmitted without interruption to other secondary batteries that follow sequentially. However, network formation between secondary batteries may be complicated, and the production cost of secondary batteries may increase.

The disclosed technology can be implemented in some embodiments to provide an energy storage system and a battery pack including a network that can reduce complexity when communicating between a plurality of secondary batteries.

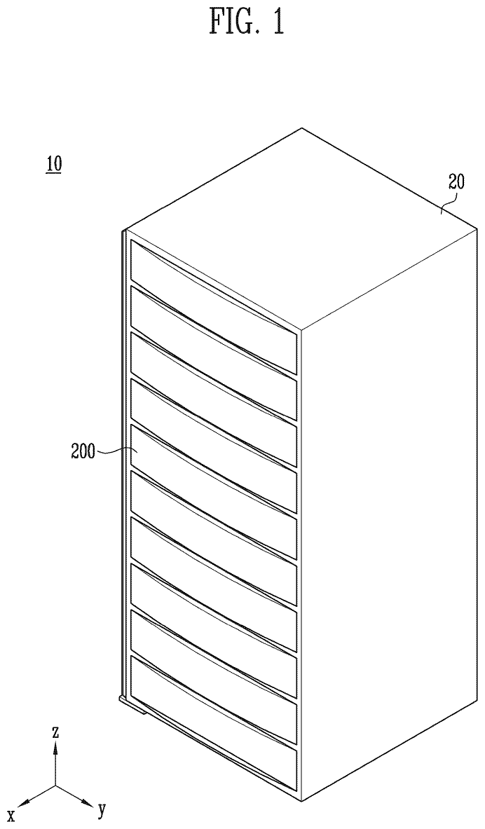

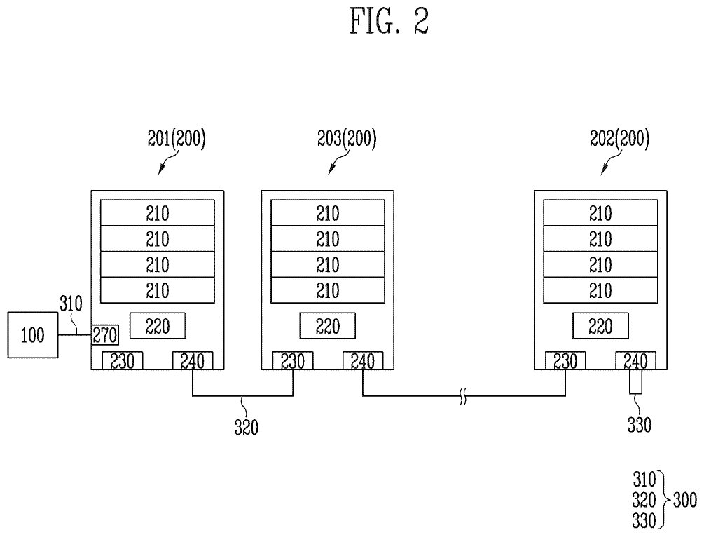

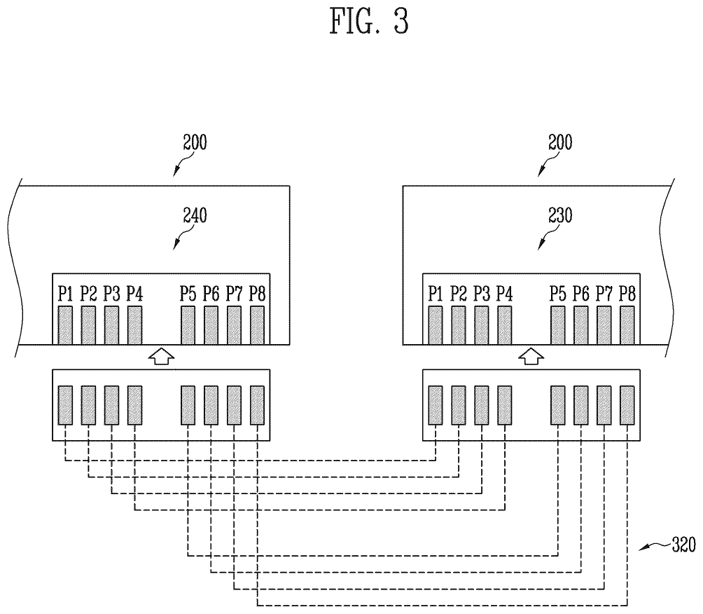

FIG. 1 shows an example of an energy storage system 10 based on an embodiment of the disclosed technology. FIG. 2 shows an example of a network (e.g., ethernet network) based on an embodiment of the disclosed technology. FIG. 3 shows examples of battery racks 200 connected to each other by a first connection line 310 implemented based on an embodiment of the disclosed technology.

Referring to FIG. 1, an energy storage system 10 implemented based on an embodiment of the disclosed technology is a system that can store electricity in energy storage devices such as batteries and can supply electricity when necessary. For example, energy may be temporarily stored in batteries disposed in a battery rack 200, and the stored energy may be supplied to an external device. In some implementations, The energy storage system 10 may charge the batteries disposed in the battery rack 200 to store electrical energy and supply electrical energy to an external device.

Referring to FIG. 1, in some implementations, the energy storage system 10 may include a plurality of battery racks 200 and a rack housing 20 accommodating the plurality of battery racks 200. The rack housing 20 may protect a battery rack 200 from external shock, heat, vibration, etc. In some implementations, the rack housing 20 may include an accommodating portion structured to accommodate a battery rack 200, and a battery rack 200 may be positioned in the accommodating portion to form an energy storage system 10.

Referring to FIG. 2, in some implementations, the battery rack 200 may include a plurality of battery cells 210. In some implementations, the plurality of battery cells 210 may include a secondary battery that can be used repeatedly by charging and discharging electrical energy. For example, the plurality of battery cells 210 may include a lithium secondary battery or a lithium ion battery, but is not limited thereto. As another example, the plurality of battery cells 210 may include an all-solid-state battery.

In some implementations, the energy storage system 10 controls a plurality of battery racks 200 and/or battery cells 210 in the battery racks 200 to store energy and supply a desired amount of energy. For example, an energy storage system 10 checks and inspects the status of a battery rack 200 and controls charging and discharging of each battery rack 200. To this end, an energy storage system 10 may further include a management control portion (or management controller) 100 that can manage and/or control operations associated with a plurality of battery racks 200.

For example, the management control portion 100 may check and inspect the performance of a battery rack 200 and control charging and discharging of a battery rack 200. The management control portion 100 may communicate with a plurality of battery racks 200 through electrical signals.

In some implementations, the management control portion 100 may include a power management system (PMS) or a system battery management system (BMS) that can coordinate energy sources and storage systems. In some implementations, the plurality of battery racks 200 may be managed by monitoring energy consumption within an energy storage system and/or by predicting power demand using a PMS and a system BMS.

In some implementations, the energy storage system 10 may further include one or more connection lines 300 for communication between the management and control portion 100 and the plurality of battery racks 200. In some implementations, the one or more connection lines 300 may include one connection line that connects the management control portion 100 and the plurality of battery racks 200 to form a network. For example, information about the current, voltage, charging, and discharging states of a battery rack 200 may be transmitted to the management control portion 100 through such a connection line 300.

For example, the network formed by connecting the management control portion 100 and the plurality of battery racks 200 may be an ethernet-based network, a controller area network (CAN) communication network, or a serial peripheral interface (SPI) communication network. The type of network is not limited as long as a plurality of battery racks 200 may be connected to each other.

In an embodiment, the one or more connection lines 300 may include an ethernet cable for providing communications based on certain communication protocols including IEEE 802.3 Ethernet standards. In some implementations, the connection line 300 may include a standardized networking interface such as an RJ45 (Registered Jack 45) terminal. In some implementations, the connection line 300 may include a plurality of cables. For example, the connection line 300 may include eight cables, and each cable may perform a transmission and/or reception function.

In some implementations, the connection line 300 may include a main cable and an auxiliary cable. In an embodiment, each of the main cable and the auxiliary cable may include two transmission cables and two reception cables. In this way, information may be transmitted between the management control portion 100 and the plurality of battery racks 200 through the connection line 300.

In some implementations, the one or more connection lines 300 may include a first connection line 310, an intermediate connection line 320, and a second connection line 330. In some implementations, the first connection line 310 may connect a first battery rack 201, which is first connected to the management control portion 100 on the network among the plurality of battery racks 200 to the management control portion 100. In some implementations, one end of the first connection line 310 may be connected to the management control portion 100, and the other end of the first connection line 310 may be connected to the first battery rack 201, so that the management control portion 100 and the first battery rack 201 may be connected to each other. As described above, in some implementations, the first connection line 310 may include a plurality of cables. Referring to FIG. 2, in an embodiment, any one battery rack 201 among a plurality of battery racks 200 may further include a third port 270 to be connected to the management control portion 100.

In some implementations, an intermediate connection line 320 may connect the plurality of battery racks 200 to each other. In one example, the intermediate connection line 320 may connect a second port 240 of any one battery rack 200 among a plurality of battery racks 200 to a first port 230 of another battery rack 200 adjacent to the any one battery rack 200. In some implementations, one end of the intermediate connection line 320 may be connected to a second port 240, and the other end of the intermediate connection line 320 may be connected to a first port 230. In some implementations, the intermediate connection line 320 may include a plurality of cables.

In some implementations, the management control portion 100, the first connection line 310, the battery rack 200, and the intermediate connection line 320 may be connected to form an ethernet network to communicate with each other.

In some implementations, the battery rack 200 may include a rack control portion (or rack controller) 220 that can receive information from the management control portion 100 and can control the battery rack 200 and/or battery cells in the battery rack 200. A rack control portion 220 may be provided inside a battery rack 200. In some implementations, the rack control portion 220 may manage or maintain information on a plurality of battery cells 210 included in a battery rack 200. For example, the rack control portion 220 may measure the voltage and current of each of the plurality of battery cells 210 and transmit the information. In addition, in some implementations, the rack control portion 220 may communicate with other battery racks 200 and the management control portion 100 through a network formed by the connection line 300.

In some implementations, the battery rack 200 may include a first port 230 and a second port 240 for receiving external electrical signals and transmitting electrical signals externally. In some implementations, the first port 230 and the port 240 may each perform both transmission and reception functions. In this way, a battery rack 200 may communicate with the outside.

In some implementations, the first port 230 and the second port 240 may include a plurality of pins to be connected to the connection line 300. To correspond to the connection line 300, the first port 230 and the second port 240 may include the same number of pins as the number of cables of the connection line 300. In this way, each cable may be connected to each pin in a one-to-one correspondence.

In some implementations, a first port 230 may be connected to a main cable and an auxiliary cable. In some implementations, half of a plurality of pins included in the first port 230 may be connected to the main cable, and the other half may be connected to the auxiliary cable.

In some implementations, a second port 240 may be connected to a main cable and an auxiliary cable. In some implementations, half of a plurality of pins included in the second port 240 may be connected to a main cable, and the other half may be connected to the auxiliary cable.

In this way, the first connection line 310 may connect the management control portion 100 and the battery rack 200, and the second connection line 330 may connect different battery racks 200 to each other.

FIG. 3 shows any one battery rack 200 and another adjacent battery rack 200 connected by a second connection line 330.

Referring to FIG. 3, each of a first port 230 and a second port 240 may include a total of eight pins from a first pin P1 to an eighth pin P8. Each of a plurality of pins may be connected to a plurality of cables of a connection line 300.

In some implementations, a plurality of pins included in the first port 230 may be connected to a plurality of pins included in the second port 240 in a one-to-one correspondence. For example, a plurality of pins may sequentially connected such that a first pin P1 of the first port 230 is connected to a first pin P1 of the second port 240, and a second pin P2 of the first port 230 is connected to a second pin P1 of the second port 230, and an 8th pin P8 of the first port 230 is connected to an 8th pin of a battery rack 240.

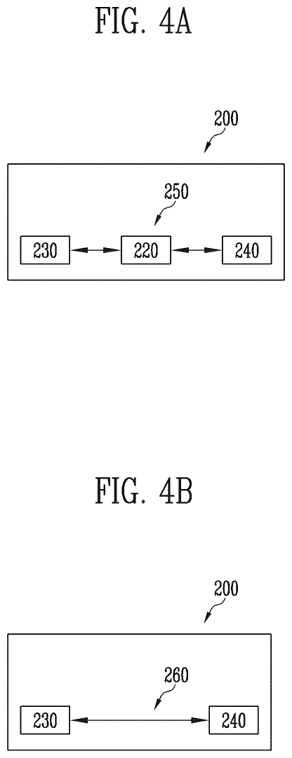

FIGS. 4A and 4B show examples of a first channel 250 and a second channel 260 based on an embodiment of the disclosed technology.

In some implementations, a battery rack 200 may include the first channel 250 and a second channel 260 for internally transmitting electrical signals between a first port 230 and a second port 240. In some implementations, signals may be transmitted between the first port 230 and the second port 240 through the first channel 250 and the second channel 260. For example, an electrical signal received by the first port 230 may be transmitted to the second port 240 through the first channel 250. In addition, an electrical signal received by the first port 230 may be transmitted to the second port 240 through the second channel 260.

In some implementations, the first channel 250 and the second channel 260 may transmit electrical signals in both directions. In other words, the first channel 250 and the second channel 260 may transmit, to the second port 240, a signal that is input to the first port 230, and conversely, a signal that is input to the second port 240 may be transmitted to the first port 230.

In some implementations, the first channel 250 and the second channel 260 may be activated simultaneously. For example, a signal that is input to the first port 230 may be transmitted to the second port 240 through the first channel 250 and at the same time, it may be transmitted to the second port 240 through the second channel 260. In this way, electrical signals may be transmitted stably.

In some implementations, the first channel 250 and the second channel 260 may receive and transmit information through an intermediate connection line 320. In some implementations, the intermediate connection line 320 may include a plurality of cables, and a part of the plurality of cables may be connected to the first channel 250 and a remaining part of the plurality of cables may be connected to the second channel 260.

In an embodiment, the number of cables connected to the first channel 250 may be the same as the number of cables connected to the second channel 260. For example, two transmission cables and two reception cables may be connected to the first channel 250, and two transmission cables and two reception cables may be connected to the second channel 260. Through this, stability of communication may be improved.

Referring to FIG. 4A, in some implementations, electrical signals of the first channel 250 may be transmitted through a rack control portion 220. In other words, electrical signals may be transmitted between the first port 230 and the second port 240 through a rack control portion 220. For example, the rack control portion 220 may include a switching circuit, and electrical signals may be transmitted between the first port 230 and the second port 240 through the switching circuit.

In addition, in some implementations, the rack control portion 220 may control a battery rack 200 based on an electrical signal of the first channel 250. For example, the rack control portion 220 may control charging and discharging of the battery rack 200 based on an electrical signal transmitted from the management control portion 100 and transmitted to the first channel 250.

Referring to FIG. 4B, electrical signals of the second channel 260 may be physically transmitted within a plurality of battery racks 200. In some implementations, electrical signal of the second channel 260 may be transmitted through a flexible circuit board included within a battery rack 200. For example, the battery rack 200 may include a flexible circuit board on which a conductive pattern is formed for electrical connection between the first port 230 and the second port 240. In this way, electrical signals may be transmitted from the first port 230 to the second port 240 even without passing through the rack control portion 220.

In some implementations, electrical signals transmitted by the management control portion 100 on a network may be transmitted to the battery rack 200 through each of the first channel 250 and the second channel 260. In some implementations, signals transmitted through the first channel 250 may control a battery rack through the rack control portion 220. In some implementations, signals transmitted through the second channel 260 may be transmitted without passing through the rack control portion 220.

When communication in any one of first channels 250 is interrupted, an ethernet-based network may be formed through a second channel 260. For example, due to damage to the rack control portion 220, communication in the first channel 250 may be disconnected, and an electrical signal that is input to the first port 230 may not be transmitted to the second port 240. Even in this case, the electrical signal that is input to the first port 230 is transmitted to the second port 240 through the second channel 260, thereby forming an ethernet-based network.

However, in some implementations, since the second channel 260 does not communicate with the rack control portion 220, the battery rack 200 may not be controlled based on signals transmitted by the second channel 260. Therefore, electrical signals transmitted by the second channel 260 need to be transmitted to the first channel 250.

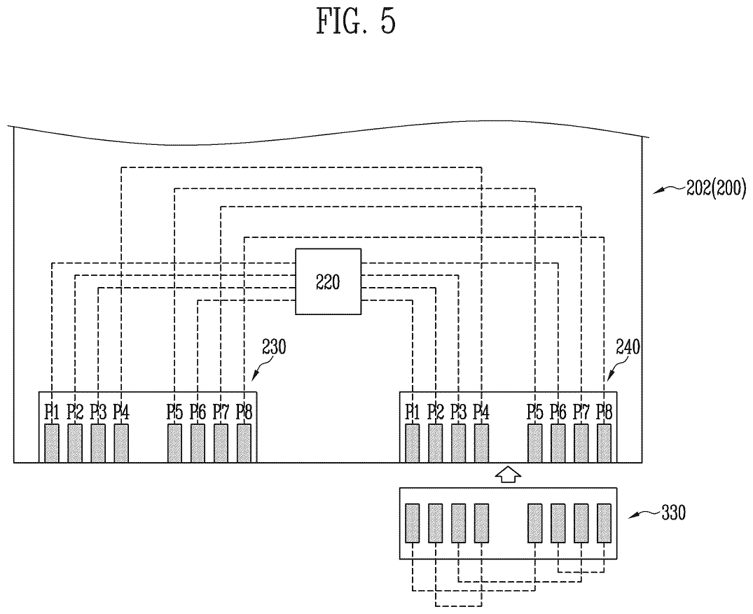

FIG. 5 shows an example of a second connection line 330 based on an embodiment of the disclosed technology. Specifically, FIG. 5 shows a second channel 260 and a first channel 250 being connected by the second connection line 330.

In an embodiment of the disclosed technology, the first channel 250 and the second channel 260 may be connected to each other. To this end, in some implementations, the connection line 300 may further include the second connection line 330. Referring to FIG. 5, the second connection line 330 may connect a main communication port of a second battery rack 202, which is located last among a plurality of battery racks 200, to a spare communication port of the second battery rack 202.

In some implementations, in a battery rack 200, electrical signals of the first channel 250 may be transmitted through the main communication port. In some implementations, electrical signal of the second channel 260 may be transmitted through the spare communication port. In some implementations, the main communication port may be connected to half of a plurality of pins included in a second port 240. In some implementations, the spare communication port may be connected to the other half of the pins.

In some implementations, the second connection line 330 may connect the first channel 250 and the second channel 260 to each other by connecting a plurality of pins included in the main communication port to a plurality of pins included in the spare communication port on a one-to-one basis.

For example, the main communication port may include a first pin, a second pin, a third pin, and a sixth pin of a second port 240. The pins of a main communication port may be composed of two pins that perform a transmission function and two pins that perform a reception function. In some implementations, the spare communication port may include a fourth pin, a fifth

pin, a seventh pin, and an eighth pin of a second port 240. The pins of the spare communication port may be composed of two pins that perform a transmission function and two pins that perform a reception function.

In some implementations, the second connection line 330 may connect the first pin and the fifth pin, the second pin and the fourth pin, the third pin and the seventh pin, and the sixth pin and the eighth pin. In this way, electrical signals of the second channel 260 may be transmitted to the first channel 250.

In some implementations, the main communication port and the spare communication port may be connected to form a ring network. In some implementations, the ring network refers to a type of network topology. In some implementations, the ring network may process communication through a single continuous path. In other words, in some embodiments of the disclosed technology, a network path by the first channel 250 and a network path by the second channel 260 may be connected to each other by the second connection line 330 to form a ring network.

The ring network implemented based on an embodiment of the disclosed technology may transmit signals in a first direction from a first battery rack 201 to a second battery rack 202 or in a second direction from the second battery rack 202 to the first battery rack 201 on the network. In this way, even when a rack control portion 220 of any one of a plurality of battery racks 200 is damaged, commands of a management control portion 100 may be transmitted to remaining battery racks 200.

For example, when a rack control portion 220 of any one battery rack 200 adjacent to a first battery rack 201 is damaged, the transmission of electrical signals through the first channel 250 may be interrupted. However, a second channel 260 may physically connect a first port 230 and a second port 240 by a flexible circuit board to transmit electrical signals to the rack control portion 220 regardless of damage. Therefore, a second channel 260 may transmit electric signals through the second channel 260 to a second battery rack 202 positioned last on a network.

In some implementations, a main communication port and a spare communication port may be connected by a second connection line 330, so that electrical signals of a second channel 260 may be transmitted back to a first channel 250. A management control portion 100 and each battery rack 200 may communicate with each other through a first channel 250.

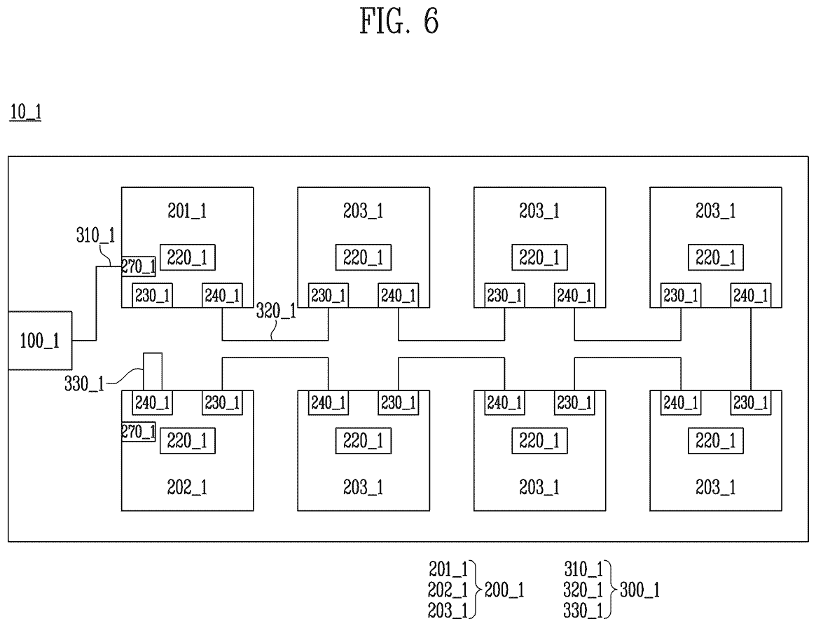

FIG. 6 shows an example of a battery pack based on an embodiment of the disclosed technology.

Referring to FIG. 6, a battery pack implemented based on an embodiment of the disclosed technology may include: a plurality of battery modules 200_1, each including a plurality of battery cells; a management control portion 100_1 controlling the plurality of battery modules; and a connection line 300 connecting the management control portion 100_1 and the plurality of battery modules to form an ethernet-based network, wherein each of the plurality of battery modules includes: a module control portion capable of communicating with the management control portion 100_1 or another battery module or controlling battery cells each included in the plurality of battery modules; and a first port 230_1 and a second port 240_1 for connection to the management control portion 100_1 or the other battery rack, wherein the connection line 300_1 includes: a first connection line 310_1 connecting a first port 230_1 of a first battery module firstly connected to the management control portion 100_1 on the network among the plurality of battery modules to the management control portion 100_1; an intermediate connection line 320_1 connecting a second port 240_1 of any one battery module among the plurality of battery modules on the network to a first port 230_1 of another battery module adjacent to the any one battery module; and a second connection line 330_1 connecting a main communication port of a second port 240_1 of a second battery module positioned last among the plurality of battery modules on the network to a spare communication port of a second port 240_1 of the second battery module.

The battery module implemented based on an embodiment of the disclosed technology may include a battery set including a plurality of battery cells grouped together. In addition, a battery pack may refer to a battery set including a plurality of battery modules grouped together. Similar to an energy storage system 10, a battery pack may also form a network to control a plurality of battery modules. To this end, a battery pack implemented based on an embodiment of the disclosed technology may also form a network based on the above description.

In some implementations, a battery rack 200 included in an energy storage system 10 may correspond to a battery module 200_1 of a battery pack 10_1, and all of the above-described description may be applied. In addition, a rack control portion 220 may correspond to a module control portion 220_1, and functions performed by a rack control portion 220 may be performed by a module control portion 220_1.

In some implementations, a battery pack 10_1 of the disclosed technology may stably communicate with a plurality of battery modules 200_1 through a ring network.

Only a few embodiments and examples are described. Enhancements and variations of the disclosed embodiments and other embodiments can be made based on what is described and illustrated in this patent document.

What is claimed is:

1. An energy storage system comprising:
a plurality of battery racks, each of the plurality of battery racks structured to support a plurality of battery cells;
a management controller configured to be in communication with and to control the battery cells in the plurality of battery racks; and
one or more connection lines configured to connect the management controller to the plurality of battery racks to form a network;
wherein each of the plurality of battery racks includes:
a rack controller configured to communicate with the management controller or another battery rack other than a corresponding battery rack or to control battery cells included in the corresponding battery rack; and
a first port and a second port configured to connect to the other battery rack;
wherein the one or more connection lines include:
a first connection line configured to connect, to the management controller, a first battery rack that is first connected to the management controller on the network among the plurality of battery racks;
an intermediate connection line configured to connect the second port of any one battery rack among the plurality of battery racks on the network to the first port of another battery rack adjacent to the any one battery rack; and
a second connection line configured to connect a main communication port of the second port of a second battery rack positioned last among the plurality of battery racks on the network to a spare communication port of the second port of the second battery rack.

2. The energy storage system according to claim 1, wherein each of the plurality of battery racks include:
a first channel configured to transmit electrical signals between the first port and the second port through the rack controller; and
a second channel configured to transmit signals between the first port and the second port within the plurality of battery racks.

3. The energy storage system according to claim 2, wherein the connection line is connected to the first channel or the second channel to form an ethernet-based network.

4. The energy storage system according to claim 3, wherein the ethernet-based network is formed by the second channel upon interruption of communication of any one of the first channels.

5. The energy storage system according to claim 2, wherein the first channel is connected to the main communication port, and the second channel is connected to the spare communication port.

6. The energy storage system according to claim 5, wherein the main communication port and the spare communication port are connected to form a ring network.

7. The energy storage system according to claim 6, wherein the ring network is configured to transmit signals in a first direction from the first battery rack to the second battery rack or in a second direction from the second battery rack to the first battery rack on the network.

8. The energy storage system according to claim 2, wherein the intermediate connection line includes a plurality of cables, a part of the plurality of cables is connected to the first channel, and the remaining part of the plurality of cables is connected to the second channel.

9. The energy storage system according to claim 8, wherein the number of cables connected to the first channel is the same as the number of cables connected to the second channel.

10. A battery pack comprising:
a plurality of battery modules, each of the plurality of battery module including a plurality of battery cells;
a management controller configured to be in communication with, and to control, the plurality of battery modules; and
one or more connection lines coupled to connect the management controller and the plurality of battery modules to form an ethernet-based network;
wherein each of the plurality of battery modules includes:
a module controller configured to communicate with the management controller or another battery module other than a corresponding battery module or to control battery cells included in the corresponding battery module; and
a first port and a second port configured to connect to the management controller or the other battery rack;
wherein the connection line includes:
a first connection line configured to connect, to the management controller, a first port of a first battery module that is first connected to the management controller on the network among the plurality of battery modules;
an intermediate connection line configured to connect a second port of any one battery module among the plurality of battery modules on the network to a first port of another battery module adjacent to the any one battery module; and
a second connection line configured to connect a main communication port of a second port of a second battery module positioned last among the plurality of battery modules on the network to a spare communication port of the second port of the second battery module.

11. The battery pack according to claim 10, wherein each of the plurality of battery modules includes:
a first channel configured to transmit electrical signals between the first port and the second port through the module controller; and
a second channel configured to transmit signals between the first port and the second port within the plurality of battery racks.

12. The energy storage system according to claim 11, wherein the first channel is connected to the main communication port, and the second channel is connected to the spare communication port.
